(19) United States
(12) Patent Application Publication
(10) Pub. No.: US 2009/0047998 A1
(43) Pub. Date: Feb. 19, 2009

(54) METHOD AND APPARATUS FOR CONTROLLING POWER TRANSMISSION LEVELS FOR A MOBILE STATION HAVING TRANSMIT DIVERSITY

(75) Inventor: WILLIAM P. ALBERTH, JR., PRAIRIE GROVE, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/840,128

(22) Filed: Aug. 16, 2007

(51) Int. Cl. H04M 1/02

(52) U.S. Cl. 455/562.1; 455/574

(57) ABSTRACT

A mobile communication device (100) of the embodiments will have a transmit diversity antenna system (613) that will comprise at least two antennas and processor/s (607) that will run a transmit diversity control module (609) for controlling transmit diversity output power. Using a power curve, the mobile communication device (100) determines whether a threshold, corresponding to an SAR value, is or may be exceeded. If the SAR threshold is not exceeded given various determined environmental conditions, the mobile communication device (100) continues transmit diversity operation. However, if SAR is about to be exceeded, or is exceeded, the mobile communication device (100) will take action and either reduce overall power, reduce power to one of the transmit diversity antennas, or deactivate one of the transmit diversity antennas in order to bring the SAR level back below the threshold.

### FIELD OF THE DISCLOSURE

The present disclosure is related to wireless mobile communications devices, such as mobile telephones, wherein such wireless communication devices employ transmit diversity in which at least two antennas are used.

### BACKGROUND

Transmit diversity is a radio communication approach that employs two or more antennas transmitting identical signals. Because the two signals will arrive at their respective common destination, the receiver, by following different radio frequency (RF) propagation paths, the chances of the received signal being hindered by RF fading at any point in time is reduced.

Further, various combing techniques on the receiver side may make use of the two or more resulting received signals, and combine them to achieve a better perceived signal strength and improved signal-to-noise ratio (SNR) at the receiver.

Mobile communications devices may therefore employ transmit diversity by incorporating at least two antennas and transmitting two identical signals. For mobile telephony the mobile communication device is usually placed against the user's ear during a phone call. The signals transmitted by the mobile communications device may therefore be blocked in some instances by the user's head, and this effect is known to RF engineers as “head loss.” The head loss is a component of an overall “path loss” which is an impedance that determines the RF energy lost in a radio transmission path between a transmitting antenna and a receiving antenna. RF engineers may estimate path loss in calculating a “link budget” which determines the amount of RF energy that must be transmitted in order for a radio signal to overcome the path loss and be strong enough to be received by the receiver equipment. The sensitivity of the receiving equipment, and various other factors, play a role in determining the link budget.

An additional design consideration in the amount of power transmitted by a mobile communication device is the “Specific Absorption Rate” (SAR), which is defined by the Federal Communications Commission (“Cellular Telephone Specific Absorption Rate (SAR),” available at: http://www.fcc.gov/cgb/sar/) as “a measure of the amount of radio frequency energy absorbed by the body when using a mobile phone.” Various organizations such as the “Mobile Manufacturers Forum,” are concerned with research, standards and regulations concerning areas such as SAR.

A mobile communications device employing mobile transmit diversity therefore, may steer the antenna pattern such that the transmit power is concentrated in a specific direction which may result in higher SAR than a mobile station using only a single antenna system, particularly in situations where a mobile station moves into fringe areas of coverage and adjusts to higher power transmission outputs to overcome distance or path loss.

Therefore, what is needed is an apparatus and method for maintaining an SAR requirement for mobile communication devices employing transmit diversity, in situations where the mobile communication power output may exceed the SAR transmission requirements.

### BRIEF DESCRIPTION OF THE DRAWINGS

FIG. 1 is a block diagram of a mobile communications device having two antennas for transmit diversity.

FIG. 2 is a diagram illustrating different radio paths for a mobile communications device using transmit diversity.

FIG. 3 is graphical representation of changes in mobile communications device output power over time due to changes in path loss between the mobile communications device and the receiving antenna.

FIG. 4 is a diagram of an exemplary mobile communication device test set up in accordance with an embodiment.

FIG. 5 is a graphical representation of a mobile communication device output power using antenna transmit diversity at various phase angles between the two antenna signals.

FIG. 6 is a block diagram of a mobile communication device in accordance with an embodiment.

FIG. 7 is a flow chart illustrating operation of a mobile communication device in accordance with the embodiments.

### DETAILED DESCRIPTION

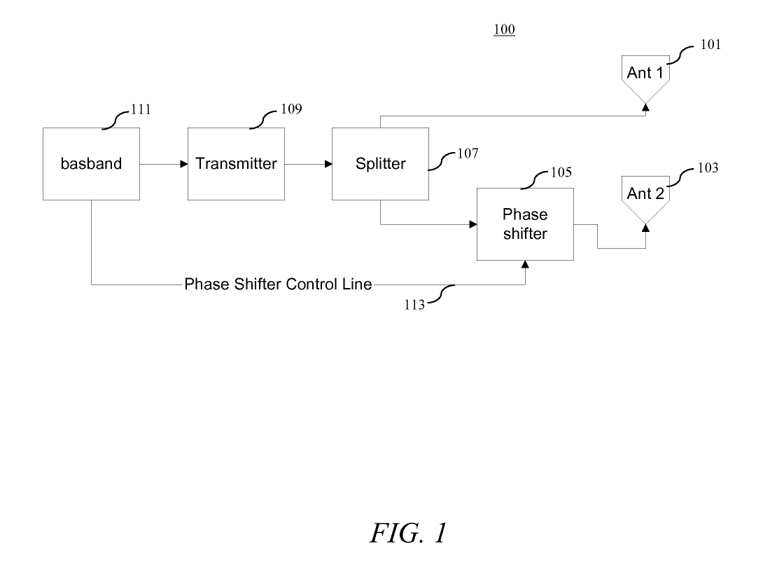

FIG. 1 illustrates an example of a mobile communication device 100 capable of transmit diversity. The mobile station 100 comprises at least two antennas, 101 and 103, and may include a phase shifter 105 and a splitter 107 connected to the transmitter 109. A baseband component 111, connected to transmitter 109, may include a phase shifter control line 113 to create a desired phase shift from the signal of antenna 101, on antenna 103. The mobile communications device 100 may therefore transmit two identical signals; a first via antenna 101 and second phase shifted version via antenna 103. One skilled in the art will recognize that other methods may be used to achieve transmit diversity and thus may be used in accordance with the embodiments described herein. For example, two transmit baseband signals may be processed by separate transmitters, each transmitter having its own antenna. By varying the baseband signals into the two transmitters a steered antenna array may be realized. One skilled in the art will further recognize that multiple transmit antennas are also applicable to Multiple Input Multiple Output (MIMO) systems such as IEEE™ 802.16 WIMAX™ systems, however MIMO systems do not transmit identical signals over two antennas as in a transmit diversity implementation.

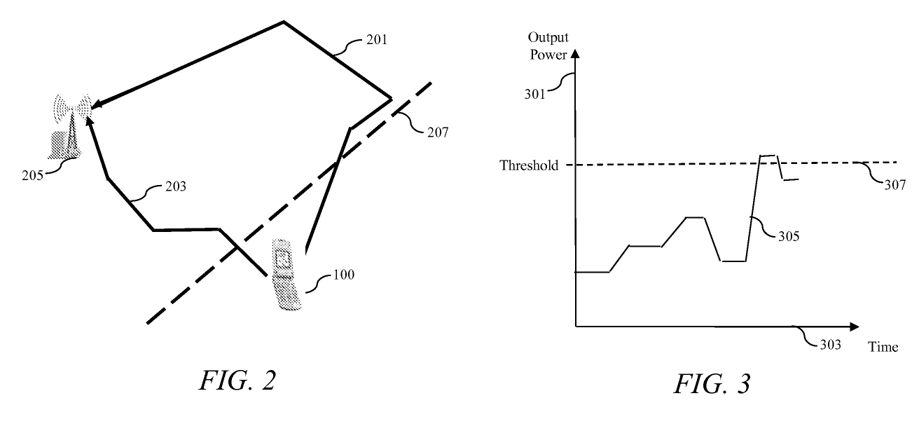

The two signals transmitted by the mobile communication device will follow differing radio propagation paths as illustrated in FIG. 2. The mobile communication device 100 communicates with one or more base transceiver stations (BTS) such as BTS 205. Each antenna of the mobile communication device 100 will produce a radio signal having a radio propagation path, for example radio propagation path 201 and radio propagation path 203. The BTS 205 may receive both signals, via the two propagation paths, and may combine the two signals to obtain a stronger overall signal or a better Signal-to-Noise Ratio (SNR).

As the mobile communication device travels through the radio network and the radio coverage areas of various BTS such as BTS 205, it will adjust its power levels to accommodate the path loss encountered. For example, in FIG. 2, as the mobile communication device 100 reaches the edge of the BTS 205 coverage area illustrated by dotted line 207, it may need to increase its power output to overcome noise levels, fading, or radio propagation obstacles such as buildings, such that the BTS 205 may still receive the signal.

The output power of the mobile communication device 100 over time may therefore look approximately like the power output graph illustrated in FIG. 3. The mobile communication device 100 output power is represented by the vertical axis 301 while the horizontal axis 303 represents time. As the mobile communication device 100 transmits, the power output 305 will be adjusted by, for example, various power control algorithms of the mobile communication device 100 processing. The mobile communication device 100 may have a requirement for “Specific Absorption Rate” (SAR), and the SAR requirement may be violated when the mobile station power output 305 exceeds a threshold 307. In the various embodiments, the mobile communication device 100 may deactivate one of its transmit diversity antennas if such a power threshold 307 is exceeded.

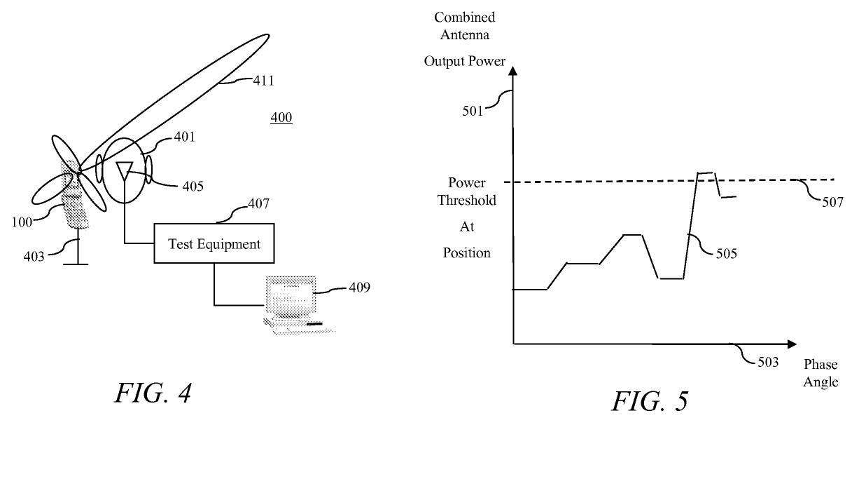

FIG. 4 illustrates an example test setup 400 that may be used to determine parameters of output power. The mobile communication device 100 may be positioned using a test stand 403 which allows the mobile communication device 100 to be positioned at various heights and angular positions with respect to a test head 401. The test head 401 may be made from a material having characteristics similar to human tissue, may have ears, and may have a test receiving antenna 405 embedded within the test head 401 material. The test receiving antenna 405 may be coupled to a test equipment 407 which is suitable for measuring the SAR of the test head 401 for various positions of the mobile communication device 100. The SAR may be determined either directly by the test equipment 407 or the test equipment 407 may provide a set of output parameters that require further computation using, for example, a computer 409, to obtain the SAR values. The mobile communication device 100 may be positioned as it would be normally used, for example, where the mobile communication device is positioned relatively vertically, or at a slight angle from its vertical axis, and pressed against the test head 401 ear so as to simulate typical use by a person on a phone call.

By adjusting the phase shifter 105 setting between the transmit antennas at various power output levels of the mobile communication device 100, an antenna pattern 411 will emerge from which the test head antenna 405 may measure the power level absorbed by the test head 401 material. Thus data may be collected such as that represented in an exemplary only fashion by FIG. 5. In FIG. 5, with the vertical axis 501 representing the combined antenna output power and the horizontal axis 503 representing the phase angle difference between the two antenna signals, a power curve 505 may be obtained for indicating the power absorbed by the test head 401, and for determining whether the power levels have exceeded a threshold 507. The graphical representation may alternatively directly plot SAR for various power and phase angle combinations as appropriate to determine whether the SAR has exceeded a threshold 507.

The threshold 507 represents an SAR threshold as may be determined or recommended by various regulatory or standards organizations such as, but not limited to the FCC. However, manufacturers may set the threshold 507 below such recommended levels if desired. The power curve 505 may be incorporated into the mobile communication device 100 in accordance with the embodiments.

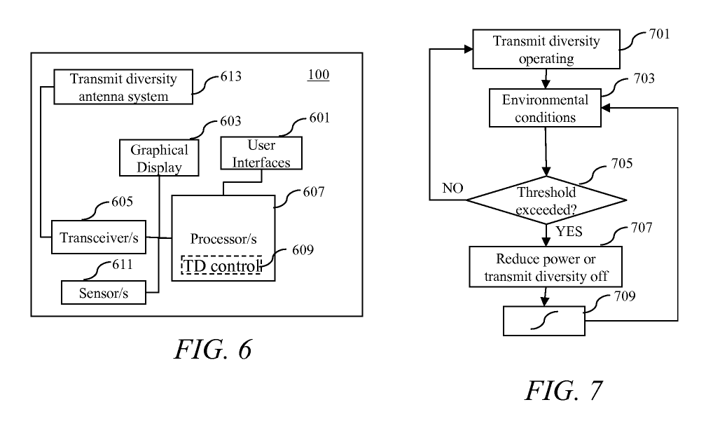

FIG. 6, illustrates the mobile communication device 100 in accordance with the embodiments. Mobile communication device 100 comprises, among other components not shown, user interfaces 601, graphical display 603, transceiver/s 605 and processor/s 607. The mobile communication device 100 of the various embodiments will have transmit diversity antenna system 613 that will comprise at least two antennas. Processor/s 607 runs a transmit diversity control module 609 for controlling transmit diversity output power by interfacing with transceiver/s 605 in accordance with the embodiments.

It is to be understood that FIG. 6 is for illustrative purposes only and is for illustrating the main components of a mobile communication device in accordance with the presently disclosed embodiments, and is not intended to be a complete schematic diagram of the various components and connections therebetween required for a mobile communication device. Therefore, a mobile communication device may comprise various other components not shown in FIG. 6 and still be within the scope of the presently disclosed embodiments.

Returning to FIG. 6, the mobile communication device 100 may further comprise sensors 611, such as, but not limited to, position and photo sensors that may be used to determine a user's hand and finger position, the angular position of the mobile communication device 100 with respect to a vertical or horizontal axis, whether the mobile communication device 100 is attached to the user's belt using a clip, or against the user's face as would be the case during a phone call. Sensors 611 may also comprise environmental sensors such as sensors for determining ambient noise, temperature, etc. The sensors of the mobile communication device 100 may be implemented in accordance with a system as described in U.S. Pat. No. 6,657,595 “SENSOR-DRIVEN ADAPTIVE COUNTERPOISE ANTENNA SYSTEM” (issued Dec. 2, 2003), which is hereby incorporated by reference herein. Further, the mobile communication device 100 may comprise a system for determining phase angles and magnitude differences as described in U.S. Patent Application Publication No. 2007/0004344, application Ser. No. 11/170,329, “WIRELESS DEVICE AND SYSTEM FOR DISCRIMINATING DIFFERENT OPERATING ENVIRONMENTS” (published Jan. 4, 2007) which is hereby incorporated by reference herein.

The transmit diversity control module 609 may utilize data from the sensors 611 in combination with the output power curve 505 to determine, or predict, when an SAR threshold 507 may be exceeded by the transceiver/s 605 for a given set of conditions including the output power and phase angle of the transmit diversity antenna system 613.

FIG. 7 is a flow chart illustrating operation of a mobile communication device 100 in accordance with the embodiments. In 701, transmit diversity is operational. In 703, the mobile communication device 100 may employ environmental sensors 611 to make various determinations such as whether the mobile communication device 100 is against the user's ear and head, whether the user is merely holding the mobile communication device 100, or whether the device is in a belt clip against the user's hip.

Using the power curve 505, in 705 the mobile communication device 100 will determine whether a threshold, corresponding to an SAR value, is or may be exceeded. If the SAR threshold is not exceeded given the determined environmental conditions 705, then the mobile communication device 100 continues transmit diversity operation in 701.

If the SAR is about to be exceeded, or is exceeded in 705, the mobile communication device 100 will take action in 707 and either reduce overall power, reduce power to one of the transmit diversity antennas, change the phase angle between the antennas, restrict the allowed settings of the phase shifter, or deactivate one of the transmit diversity antennas in order to bring the SAR level back below the threshold.

It is to be understood that block 707 may include other methods, as understood by one of ordinary skill, such as, but not limited to, various techniques applicable to phased antenna arrays, to restrict the radiation pattern generated by the plurality of antennas so as to prevent SAR from exceeding the threshold, and remain in accordance with the embodiments disclosed herein.

In 709, a hysteresis is applied for stability and to avoid the “popcorn effect” of switching between transmit diversity states if the threshold of the power curve 505 switches abruptly above and below the threshold for some period of time.

After the environmental conditions 703 are acceptable and the threshold condition 705 is acceptable, the mobile communication device may return to transmit diversity operation as in 701.

While various embodiments have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method of operating a mobile station, said mobile station having at least two antennas for operating in a transmit diversity mode, the method comprising:
operating said mobile station in a transmit diversity mode;
monitoring an output of said mobile station;
comparing said output to a power curve;
determining that said output will exceed a threshold based on said power curve; and
adjusting a parameter to bring said output within said threshold.

2. The method of claim 1, further comprising:
monitoring a sensor of said mobile station;
determining that said mobile station is against a user's ear based on an output of said sensor.

3. The method of claim 1, wherein monitoring said output further comprises:
monitoring at least one of power output or phase angle.

4. The method of claim 1, wherein determining that said output will exceed a threshold based on said power curve, further comprises:
determining that said output will exceed a Specific Absorption Rate (SAR) threshold.

5. The method of claim 1, wherein adjusting a parameter to bring said output within said threshold, further comprises:
reducing overall power output of said mobile station while operating in said transmit diversity mode.

6. The method of claim 1, wherein adjusting a parameter to bring said output within said threshold, further comprises:
reducing power to one of said at least two antennas while operating in said transmit diversity mode.

7. The method of claim 1, wherein adjusting a parameter to bring said output within said threshold, further comprises:
changing the phase angle between said at least two antennas while operating in said transmit diversity mode.

8. The method of claim 1, wherein adjusting a parameter to bring said output within said threshold, further comprises:
deactivating said transmit diversity mode and operating in a single antenna mode.

9. The method of claim 1, wherein adjusting a parameter to bring said output within said threshold, further comprises:
restricting a relationship parameter, said relationship parameter defining a difference between a first input signal and a second input signal, applied respectively to a first antenna and a second antenna of said at least two antennas, said difference being limited by said restricting said relationship parameter.

10. A mobile station comprising:
a transmit diversity antenna system having at least two antennas, said transmit diversity antenna system for transmitting at least two identical signals over said at least two antennas wherein one of said at least two identical signals is phase shifted from the other of said at least two identical signals; and
a processor coupled to said transmit diversity antenna system, said processor configured to operate said mobile station in a transmit diversity mode, monitor an output of said mobile station, compare said output to a predetermined power curve, determine that said output will exceed a threshold based on said power curve; and adjust a parameter to bring said output within said threshold.

11. The mobile station of claim 10, further comprising:
a sensor coupled to said processor, said sensor for providing an indication that said mobile station is against a user's body.

12. The mobile station of claim 10, wherein said processor is further configured to monitor said output by monitoring at least one of power output or phase angle.

13. The mobile station of claim 10, wherein said processor is further configured to determine that said output will exceed a threshold based on said power curve by determining that said output will exceed a Specific Absorption Rate (SAR) threshold.

14. The mobile station of claim 10, wherein said processor is further configured to adjust a parameter to bring said output within said threshold by reducing overall power output of said mobile station while operating in said transmit diversity mode.

15. The mobile station of claim 10, wherein said processor is further configured to adjust a parameter to bring said output within said threshold by reducing power to one of said at least two antennas while operating in said transmit diversity mode.

16. The mobile station of claim 10, wherein said processor is further configured to adjust a parameter to bring said output within said threshold by changing the phase angle between said two identical signals while operating in said transmit diversity mode.

17. The mobile station of claim 10, wherein said processor is further configured to adjust a parameter to bring said output within said threshold by deactivating said transmit diversity mode and operating in a single antenna mode.
